(19) United States
(12) Patent Application Publication
(10) Pub. No.: US 2010/0295289 A1
(43) Pub. Date: Nov. 25, 2010

(54) SECURITY ELEMENT COMPRISING A DISCERNIBLE DESIGN

(75) Inventors: Pierre Doublet, Saint Brice (FR); Michel Camus, Rives Sur Fure (FR); Stephane Mallol, Provins (FR); Ivan Thierry, Jouy Sur Morin (FR)

Correspondence Address: Oliff & Berridge, PLC, P.O. Box 320850, Alexandria, VA, 22320-4850, US

(73) Assignee: ARJOWIGGINS SECURITY, Issy Les Moulineaux (FR)

(21) Appl. No.: 12/303,018

(22) PCT Filed: Jun. 6, 2007
(86) PCT No.: PCT/FR2007/051386

§ 371 Date: Nov. 5, 2009

(30) Foreign Application Priority Data
Jun. 6, 2006 (FR) 06 05020

(51) Int. Cl. B42D 15/00

(52) U.S. Cl. 283/81; 283/72; 283/85

(57) ABSTRACT

The present invention concerns a flat safety element, comprising a support that contains, on at least one of its faces, a set of elementary characters, characterized in that said elementary characters are equipped with a variation in shape and/or density and/or size in such a manner as to ensure a detectable design is at least visible.

The invention relates to a flat security element comprising a discernible design, and to the security sheet or item containing it.

In the security documents industry, use is commonly made of security threads which are incorporated into these documents. Such threads may bear printed inscriptions, but these may have the disadvantage of being too visible under reflected light and therefore relatively easily reproduced by counterfeiters or forgers who print the design of the thread onto paper.

Document EP 0 536 855 discloses a security thread comprising a plastic backing and inscriptions obtained by depositing metal in such a way that, when the thread is incorporated into a document, the inscriptions are practically invisible under reflected light and can be discerned only under transmitted light. Thus, the protection of the security documents against falsification is improved. However, when the thickness of paper between the security thread and the exterior face of the layer of paper is too small, the inscriptions may appear under reflected light. In addition, because the inscriptions are created by metallization, the choice of shapes and colors is relatively limited.

It is therefore an object of the present invention to propose a security element, such as a security thread, strip or patch which further improves the protection afforded to the document into which it is incorporated.

The Applicant Company has found that a nonuniform layout of elementary characters present on at least one of the faces of the security element allows this object to be achieved.

Thus, a subject of the invention is a flat security element bearing on at least one of its faces a collection of elementary characters, said elementary characters having a variation in shape and/or in density and/or in size that allows at least one discernible design to be revealed.

These designs may represent alphanumeric designs, symbols, patterns or the like.

What is meant here by “discernible” is that the design is discernible, against the background also made up of elementary characters, by the observer looking through and/or via reflection at the security document comprising the security element according to the invention. The designs are not necessarily discernible when the security element is observed from a close distance, for example through a magnifying glass. This is because at close range, the outlines of the designs are not sharp and layout of the elementary characters appears to be random.

The elementary-character density corresponds to the number of elementary characters per unit surface area of the backing of the security element.

According to the invention, the variation in the density and/or in the shape and/or in the size of the elementary characters allows the observer, through the contrast afforded by this or these variations, to distinguish zones that form the designs from the background of the security element. Thus, in spite of the seemingly random layout of the elementary characters, the observer can recognize the designs.

Another advantage of the invention is that this variation makes falsification particularly difficult. Specifically, because of the variable nature of the elementary characters, it is particularly difficult to reproduce their layout.

Yet another advantage of the invention is that the security element can be authenticated by checking the shape and layout of the elementary characters using a microscope or suitable magnifying device.

The backing of the security element according to the invention is preferably made of a transparent or translucent material. In particular, the backing is made of plastic. Suitable materials are those based on polymers chosen from the group of polyesters, particularly poly(ethylene terephthalate), polypropylenes, polyethylenes, polyvinyl chloride and mixtures thereof.

The backing of the security element has a thickness of between 5 and 700 μm, preferably of between 5 and 200 μm, and more preferably still of between 5 and 50 μm.

According to one embodiment of the invention, the elementary characters arranged at the surface of the security element may be dots and/or segments of straight lines and/or segments of curves and/or combinations thereof. A combination such as this may, for example, lead to elementary characters that have geometric shapes, such as quadrilaterals, triangles, disks, circles, or figures such as stars, quarter moons or half moons or the like.

As an alternative, the characters arranged at the surface of the security element according to the invention have an irregular shape, that is to say a form that is nongeometric and which varies in size (of the type known as a “potatoid”).

According to one embodiment of the invention, the various elementary characters arranged on one of the faces of the security element may all be of the same shape. For example, the security element comprises at its surface a collection of elementary characters in the shape of stars the density of which varies. In another example, the security element comprises at its surface a collection of stars of different sizes.

According to another embodiment, the various elementary characters arranged at the surface of the security element are not all of the same shape. For example, the security element comprises at its surface a collection of dots, of curved segments and of stars.

According to one particular embodiment of the invention, the elementary characters have different shapes and the shapes of the elementary characters of the designs and of the background are the same. For example, both the background and the discernible designs are formed of dots and of segments of straight lines the variation in density and/or in size of which reveals said discernible designs.

In another embodiment, the elementary characters arranged in the zone or zones that form one or more design(s) are different than the elementary characters arranged outside of the zone or zones that forms or form the designs. Thus, for example, the background may be made up of dots and the patterns of segments of straight lines. It is also possible for each design-forming zone to be made up of elementary characters different than the elementary characters of which the other design-forming zones are made up.

According to one particular embodiment of the invention, the elementary-character density is constant over the entire security element.

According to another embodiment, the elementary-character density may be higher in a zone corresponding to a design so that said design will seem to the observer to be darker than the background surrounding it.

Conversely, the elementary-character density may be lower in a zone corresponding to a design so that said design appears to the observer to be lighter than the background surrounding it.

In a preferred embodiment of the invention, the security element comprises at its surface elementary characters made up of a collection of dots. The density of these dots is higher in the zones that form a design than in the background of the security element.

According to one embodiment of the invention, the elementary characters have a size of between 50 and 100 μm.

According to one embodiment of the invention, the size of the elementary characters of the security element is constant, only the density and/or the shape of said elementary characters varying. For example, the elementary characters are made up of dots with a diameter of 60 μm.

According to another embodiment, the size of the elementary characters arranged on the backing of the security element varies. In particular, when the density and shape of the elementary characters are constant, the elementary characters may be smaller in size in the zones that form the designs than the elementary characters that form the background, which means that said designs appear paler than the background surrounding them. Conversely, the elementary characters may be of a larger size in the zones forming the designs than the elementary characters that form the background, such that said designs appear darker than the background surrounding them.

According to one particular embodiment, the size, shape and density of the elementary characters laid out on the backing of the security element according to the invention can vary simultaneously. Their degrees of variation will be chosen by those skilled in the art in such a way as to create zones, corresponding to the designs, that can be discerned from the background of the security element.

According to one embodiment of the invention, the security element may consist of a string, optionally a repeating string, of sequences, each sequence being made up of a different layout of elementary characters varying in shape and/or in density and/or in size and forming a background and designs.

According to another embodiment, the layout of the elementary characters on the backing of the security element may be designed such that the designs are discernible only when the security element is folded on itself, through the complementary nature of several zones intended to form designs. For example, in the case of a security element that has a layout of elementary characters the density of which varies, this density may be higher in complementary zones corresponding to partial designs. When the security element is folded, these complementary zones will complement one another in such a way as to reveal one or more designs darker than the background.

As a preference, said elementary characters are impressions printed in ink and/or deposits of metal.

According to one embodiment of the invention, said elementary characters are made of metal. In particular, the metal used to create the designs may be chosen from aluminum, copper, chromium and alloys of these. For example, the metal elementary characters may be deposited at the surface of the security element using a partial metallization process. They may just as easily be deposited by metalizing the surface of the backing, followed by partial demetalization.

According to a preferred scenario of the invention, the characters are printed in an opaque ink. In particular, this may be a metal ink. A suitable metal ink is, for example, an ink containing metallic pigments such as copper, aluminum, silver, gold, chromium or iron pigments. It is equally possible for the designs to be printed in a colored ink, including white or black, for example a black ink with pigments containing carbon black.

According to another particular scenario, the ink used may, in addition, have luminescent, particularly florescent or phosphorescent, properties.

For example, the elementary characters may be impressions obtained by intaglio printing, offset printing, flexographic printing, screen printing or alternatively by digital printing.

The security element according to the invention may also comprise at least one additional coating.

According to one particular scenario of the invention, the security element may comprise an electrically conductive wire, particularly made of a transparent electrically conductive polymer. Examples of suitable electrically conductive polymers are a polyanilin, a polyethylene dioxythiophene or derivatives thereof. The security element may comprise a coating that has magnetic properties, which may or may not be in combination with the electrically conductive coating.

According to another scenario of the invention, the security element may also comprise a coating that has magnetic or luminescent, particularly florescent, properties.

According to a preferred embodiment, the security element according to the invention may be produced in the form of a security thread intended to be inserted at least partially into a security document. Suitable dimensions are a width from 0.7 to 60 mm, particularly from 1 to 40 mm, and a length corresponding to the distance between a first and a second opposite edge of the document into which the security element is to be inserted.

As an alternative, the security element according to the invention may be a patch or a foil intended to be applied to a security document. The security element may then, for example, be positioned in an opening, preferably a transparent opening, made in the security document and constitute a window in said document.

What is meant here by a patch is a flat element the size of which is small by comparison with the dimensions of the security document and what is meant by a foil is a thin flat elongate element, it being possible for these elements to be affixed to the surface of a document, for example by transfer.

The invention also relates to a security sheet incorporating the above described security element. A security sheet here is a sheet, for example made of a fibrous material and/or of a plastic material, that may contain one or more security elements and that is not printed.

The invention also relates to a security item incorporating said security element. Said item is a security document, particularly a means of payment such as a banknote, a check, an identity document such as an identity card, a driver's license, a visa, a page of a passport and the like. In particular, the invention relates to a banknote into which a security element according to the invention is incorporated. As a preference, the security document is a banknote into which a security element in the form of a security thread is incorporated or to which a patch is affixed, particularly in a window. The security item may also be a security label or a wrapper, particularly one intended for drugs or for electronic components or for foodstuffs.

The security item according to the invention may comprise at least one fibrous layer, particularly based on cellulose fibers, and/or a layer of plastic.

The invention will now be described in greater detail with the aid of the attached drawing in which:

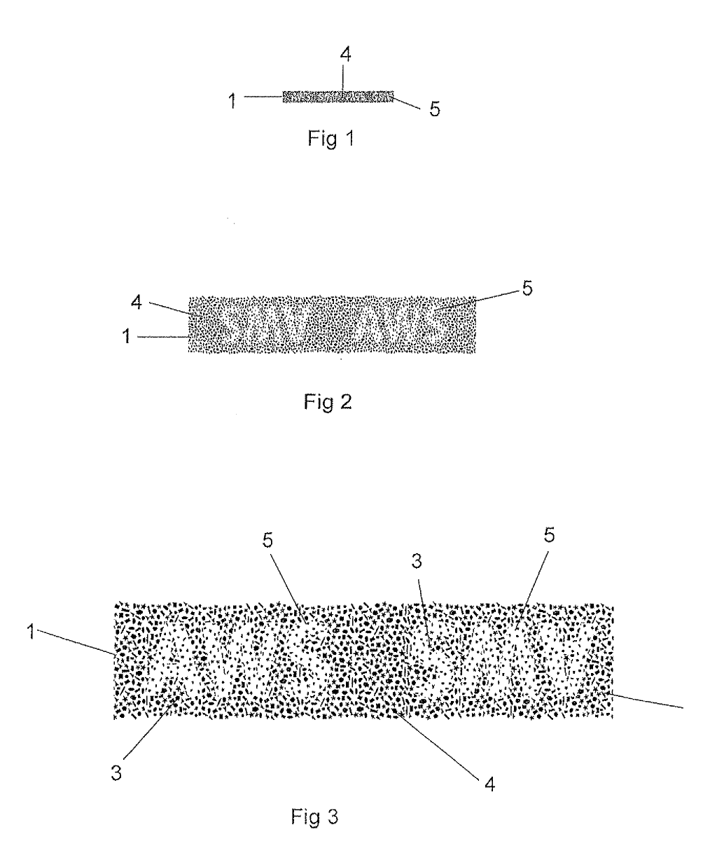

FIG. 1 depicts a front view of the security element according to one embodiment of the invention, life size;

FIG. 2 depicts a front view of the security element of FIG. 1, magnified by a factor of 5

FIG. 3 depicts a front view of the security element of FIG. 1, magnified by a factor of 10.

FIGS. 1 to 3 illustrate a security thread according to the invention at various levels of magnification.

The security thread (1) comprises a transparent backing (2) made of polyethylene terephthalate, 3 mm wide, 30 mm long and 30 μm thick, on which characters (3) in the form of circles, stars, hexagons and ovals are printed. In the example illustrated, the size and the density of the characters vary in such a way as to form a dark background (4) and discernible pale alphanumeric designs (5). The shapes of the characters (3) in the design (5) are the same as those in the background (4). As can be seen by comparing FIGS. 1 to 3, the greater the magnification, the more readily the characters (3) can be identified but the less discernible the design (5), thus making the security thread (1) very difficult to reproduce. At life size, the design (5) is perfectly discernible, the background (4) and the design (5) seeming almost uniform, and the observer cannot perceive the precise shape of each of the characters (3) printed on the surface of the transparent backing (2).

1. A flat security element comprising a backing bearing, on at least one of its faces, a collection of elementary characters, wherein said elementary characters are set out with a variation in shape and/or in density and/or in size so as to reveal at least one discernible design.

2. The security element as claimed in claim 1, wherein the backing of said security element is made of a transparent or translucent material.

3. The security element as claimed in claim 2, wherein said transparent or translucent material is based on a polymer chosen from the group of polyesters, particularly poly(ethylene terephthalate), polypropylenes, polyethylenes, polyvinyl chloride.

4. The security element as claimed in claim 1, wherein said backing of the security element has a thickness of between 5 and 700 μm.

5. The security element as claimed in claim 1, wherein it has a width greater than 0.7 mm and preferably less than 60 mm.

6. The security element as claimed in claim 5, wherein it has a width of between 1 mm and 40 mm.

7. The security element as claimed in claim 1, wherein said discernible design represents at least one alphanumeric design and/or a pattern and/or a symbol.

8. The security element as claimed in claim 1, wherein said elementary characters are dots and/or segments of straight lines and/or segments of curves and/or combinations thereof.

9. The security element as claimed in claim 1, wherein said elementary characters have geometric shapes and/or nongeometric shapes.

10. The security element as claimed in claim 1, wherein the elementary characters in the zone corresponding to the at least one discernible design are of the same shape(s) as the elementary characters outside of the zone corresponding to the said discernible design.

11. The security element as claimed in claim 1, wherein the elementary characters in the zone corresponding to the at least one discernible design are of (a) different shape(s) from that (those) of the elementary characters outside of the zone corresponding to said discernible design.

12. The security element as claimed in claim 1, wherein said elementary characters are impressions.

13. The security element as claimed in claim 12, wherein said elementary characters are impressions printed in an opaque ink.

14. The security element as claimed in claim 12, wherein said elementary characters are impressions printed in at least one metallic ink.

15. The security element as claimed in claim 1, wherein said elementary characters are deposits of metal.

16. The security element as claimed in claim 15, wherein said elementary characters are made in aluminum, in copper, in chromium, or in an alloy of these.

17. The security element as claimed in claim 1, comprising at least one additional coating.

18. The security element as claimed in claim 17, wherein said coating has properties of electrical conductivity, and/or magnetic properties and/or luminescent, particularly florescent properties.

19. The security element as claimed in claim 18, wherein said coating is a transparent electrically conductive polymer.

20. The security element as claimed in claim 1, wherein said security element is a security thread.

21. The security element as claimed in claim 1, wherein said security element is a patch.

22. The security element as claimed in claim 1, wherein said security element is a foil.

23. A security sheet, comprising at least one security element as claimed in claim 1.

24. A security item, comprising at least one security element defined in claim 1 or a security sheet comprising the at least one security element.

25. The security item as claimed in claim 24, wherein it is a security document or an identity document.

26. The security item as claimed in claim 24, wherein it is a security label or a wrapper.

27. The security item as claimed in claim 24, further comprising at least one fibrous layer.

28. The security item as claimed in claim 24, further comprising at least one layer of plastic.

29. The security element as claimed in claim 4, wherein the thickness is between 5 and 200 μm.

30. The security element as claimed in claim 29, wherein the thickness is between 5 and 50 μm.

31. The security item as claimed in claim 25, wherein it is a means of payment, or an identity card, a driver's license, a visa or a page of a passport.

32. The security item as claimed in claim 27, further comprising one fibrous layer based on cellulose fibers.
